(19) United States
(12) Patent Application Publication
(10) Pub. No.: US 2012/0259686 A1
(43) Pub. Date: Oct. 11, 2012

(54) Management Of Advertisements, Electronic Commerce, And Consumer Services

(76) Inventor: A. Pierre Yurow, Rockville, MD (US)

(21) Appl. No.: 13/441,917

(22) Filed: Apr. 9, 2012

Related U.S. Application Data
(60) Provisional application No. 61/473,844, filed on Apr. 11, 2011.

(51) Int. Cl. G06Q 30/02

(52) U.S. Cl. 705/14.17; 705/14.66; 705/14.23

(57) ABSTRACT

A computer implemented method and system for managing advertisements, electronic commerce, and consumer services are provided. An advertisement management platform, provided for managing an advertisement distribution service, registers one or more consumers with the advertisement distribution service by creating a consumer profile comprising dynamic behavioral data for each of the consumers. The advertisement management platform targets advertisements to the registered consumers based on their dynamic behavioral data. The advertisement management platform engages the registered consumers with the targeted advertisements based on an advertisement engagement plan of the advertisement distribution service. The advertisement management platform provides the registered consumers with one or more incentives when a response to the targeted advertisements confirms consumption of the targeted advertisements. An electronic commerce management server is provided for managing the electronic commerce and consumer services. A mobile wallet application is provided to each of the registered consumers for electronically storing the incentives.

### CROSS REFERENCE TO RELATED APPLICATIONS

This application claims the benefit of provisional patent application No. 61/473,844, filed on Apr. 11, 2011 in the United States Patent and Trademark Office.

The specification of the above referenced patent application is incorporated herein by reference in its entirety.

### BACKGROUND

Targeted advertising refers to a class of advertising services for product and service companies that targets consumers with relevant advertisements. Several mechanisms have been employed for targeting advertisements to consumers. However, existing systems lack an integrated management of advertisements and related consumer services, thereby either making the consumers lose interest in participating in the targeted advertisement service, or failing to provide related and value-added services to keep the consumers engaged.

Electronic commerce refers to financial and retail transactions over electronic systems such as computer networks and cellular networks. Existing systems do not provide methods to effectively integrate targeted advertising with value-added electronic commerce services for the benefit of consumers.

Hence, there is a long felt but unresolved need for a computer implemented method and system that manages advertisements, electronic commerce, and consumer services and integrates targeted advertising with consumer-beneficial electronic commerce, consumer services and incentives that make the consumer opt-in for an advertisement communication service and keep the consumer engaged with the advertisement communication service.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for managing advertisements, electronic commerce, and consumer services and for integrating targeted advertising with consumer-beneficial electronic commerce, consumer services and incentives such as subsidized mobile services to make a consumer opt-in for an advertisement communication service, to retain the interest of the consumer for the advertisement communication service, and to keep the consumer engaged with the advertisement communication service.

An advertisement management platform comprising at least one processor configured to manage an advertisement distribution service for consumers is provided. As used herein, the term “advertisement distribution service” refers to a service provided by the advertisement management platform for acquiring advertisement media from retailers, advertisers, and marketing and branding entities, performing targeted distribution of the advertisements to consumers, integrating targeted advertising with consumer-beneficial electronic commerce, consumer services and incentives to retain the interest of the consumers, etc. In an embodiment, an electronic commerce management server configured to communicate with the advertisement management platform, is provided. The electronic commerce management server comprises at least one processor configured to manage the electronic commerce and consumer services.

The advertisement management platform registers one or more consumers with the advertisement distribution service by creating a consumer profile for each of those consumers. The consumer profile comprises dynamic behavioral data of each of the registered consumers. The advertisement management platform targets advertisements to the registered consumers based on the dynamic behavioral data of the registered consumers through one or more of multiple media and communication channels. The media and communication channels comprise, for example, fixed cellular networks, mobile cellular networks, an unstructured supplementary service data channel, wireless application protocol (WAP) browsers, mobile web browsers, short message services, multimedia messaging services, internet web portals, digital television, etc. The advertisement management platform engages the registered consumers with the targeted advertisements based on an advertisement engagement plan of the advertisement distribution service. The advertisement engagement plan requires each of the registered consumers to consume and provide a response to a predetermined number of targeted advertisements within a predetermined time period. The advertisement management platform provides the registered consumers with one or more incentives, for example, coupons, vouchers, electronic currency, etc., when the response to one or more of the predetermined number of targeted advertisements confirms consumption of the targeted advertisements.

An electronic mobile wallet application executable by at least one processor is provided to each of the registered consumers for electronically storing the incentives, for example, as coupons, vouchers, and/or electronic currency. The mobile wallet application is accessible through a wide spectrum of technologies and devices, for example, a general packet radio service (GPRS), 3G, a short message service (SMS) or multimedia messaging service (MMS) message communication, a voice over internet protocol (VOIP) voice or data communication, or other internet enabled cellular phones and tablet computing devices, computers with connection to the internet, televisions with digital set top boxes, etc. The mobile wallet application is accessible on a consumer device, for example, a personal computer, a laptop, a mobile phone such as the iPhone® of Apple Inc., a personal digital assistant, a tablet computing device such as the iPad® of Apple Inc., a global system for mobile communications (GSM) device or a code division multiple access (CDMA) communication device that utilizes unstructured supplementary service data (USSD) or a wireless application protocol (WAP) browser or a mobile web browser for communicating with the advertisement management platform, a television with a digital set top box, a game console such as the PlayStation® of Sony Corporation, the Xbox® of Microsoft Corporation, the Nintendo® Wii®, other communication devices, etc. The mobile wallet application is also accessible through a web browser, for example, a wireless application protocol (WAP) browser or a mobile web browser on the consumer device via a network, for example, the internet, an intranet, a local area network (LAN), a wide area network (WAN), a communication network that implements Wi-Fi® of the Wireless Ethernet Compatibility Alliance, Inc., a cellular network, a mobile communication network, etc.

The mobile wallet application enables exchange of the incentives, for example, the coupons and the electronic currency for retail transactions using the electronic commerce management server. In an embodiment, the advertisement management platform engages the registered consumers, for example, with transaction of the coupons based on an incentive engagement plan of the advertisement distribution service. The incentive engagement plan requires each of the registered consumers to accept and redeem a predetermined number of incentives, for example, coupons within a predetermined time period. The advertisement management platform maintains the dynamic behavioral data of each of the registered consumers in a central data warehouse. The dynamic behavioral data is regularly updated in the data warehouse for each engagement of the registered consumers with the targeted advertisements and each exchange of the incentives, for example, the coupons and the electronic currency for retail transactions.

The computer implemented method and system disclosed herein provides web voice, mobile data, mobile wallet and mobile messaging services, wherein one or more of these services are fully or substantially subsidized through a loyalty program and/or with a mobile operator service plan. The service plan comprises, for example, advertising to consumers using both visual and audio content through targeted advertising engagements referred to as cost per engagement (CPE); coupon or voucher distribution referred to as cost per acquisition (CPA); coupon or voucher redemption at retail locations referred to as cost per purchase (CPP); and a targeted survey or a poll referred to as cost per survey (CPS). The computer implemented method and system disclosed herein may deliver targeted advertising over multiple media and communication channels comprising, for example, fixed and mobile voice networks, an unstructured supplementary service data (USSD) channel, wireless application protocol (WAP) browsers, mobile web browsers, a short message service (SMS), a multimedia messaging service (MMS), the internet, digital televisions, automated teller machine (ATM) screens and other multimedia, where available.

The mobile wallet application enables redemption of the incentives, for example, the coupons for retail transactions at a point of sale, the redemption of electronic cash for physical cash at a point of sale, and redemption of the incentives for the purchasing of airtime credit for mobile phone services at a point of sale. The information on one or more of the incentives, for example, the coupons, the vouchers and/or the electronic cash stored by the mobile wallet application is captured at a point of sale system in response to a request to redeem the stored coupons, vouchers and/or electronic cash by the registered consumers. The point of sale system transmits the captured information to the advertisement management platform, in real time, for validating the stored coupons, vouchers and/or electronic cash and enabling redemption of the stored coupons, vouchers and/or electronic cash for the retail transactions. The electronic commerce management server removes the stored coupons, vouchers and/or electronic cash from the mobile wallet application after the redemption of the stored coupons, vouchers and/or electronic cash at the point of sale. The electronic commerce management server tracks the exchange of the coupons and the electronic currency for the retail transactions and stores the tracked information in the data warehouse. In an embodiment, the mobile wallet application converts the electronic currency received as one or more of the incentives to equivalent airtime credit for mobile phone services and vice versa. In another embodiment, the mobile wallet application converts the electronic currency to physical currency and vice versa.

The electronic commerce management server in conjunction with the mobile wallet application provides support for additional electronic commerce services comprising loyalty programs and retail transactions. The data warehouse proactively generates consumer analytics information, for example, based on the consumer profile of each of the registered consumers, information on advertisement engagements and coupon engagements of the registered consumers, and the tracked information of the exchange of the coupons and electronic currency by the registered consumers for retail transactions. The advertisement management platform selectively provides the generated consumer analytics information, for example, to one or more retailers, advertisers, and marketing and branding service providers to allow the retailers, the advertisers, and the marketing and branding service providers to develop advertisement campaigns based on the consumer analytics information. In an embodiment, the data warehouse implements predictive analytics for predictively determining the results of the advertisement campaigns and for predicting system utilization for advertising, coupon transmissions, and coupon redemptions for each of the advertisement campaigns.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for managing advertisements, electronic commerce, and consumer services.

FIG. 2 illustrates a computer implemented system for managing advertisements, electronic commerce, and consumer services.

FIG. 3 exemplarily illustrates the architecture of a computer system employed by an advertisement management platform, an electronic commerce management server, and/or a consumer device for managing advertisements, electronic commerce, and consumer services.

FIG. 4 exemplarily illustrates a flowchart comprising the steps for providing and utilizing an advertisement distribution service of the advertisement management platform.

FIG. 5A exemplarily illustrates a flowchart of back end communication between the advertisement management platform and a point of sale for coupon or voucher redemptions.

FIG. 5B exemplarily illustrates a flowchart of a front end transaction at a point of sale for redeeming coupons or vouchers according to the computer implemented method and system disclosed herein.

FIG. 5C exemplarily illustrates a flowchart of a transaction at a point of sale having a radio frequency (RF) reader for redeeming coupons or vouchers.

FIG. 5D exemplarily illustrates a flowchart of a transaction at a point of sale that uses unstructured supplementary service data (USSD), a wireless application protocol (WAP) browser, a mobile web browser session or other similar real time sessions for validating a coupon or a voucher.

FIG. 6 exemplarily illustrates an embodiment of the advertisement distribution service, advertisement engagement, and coupon engagement of the advertisement management platform in association with a managed service organization (MSO).

FIG. 7A exemplarily illustrates a use case describing consumer registration for the advertisement distribution service provided by the advertisement management platform through a managed service organization (MSO) set top box on a television screen.

FIG. 7B exemplarily illustrates a use case describing consumer registration for the advertisement distribution service provided by the advertisement management platform through a managed service organization (MSO) using a web portal or a call center.

FIG. 7C exemplarily illustrates a use case describing a scenario where a consumer is targeted by the advertisement management platform to engage in an advertisement campaign dialog through television menus for acquiring coupons or vouchers.

FIG. 7D exemplarily illustrates a use case describing a scenario where a consumer is targeted by the advertisement management platform to engage in an advertisement campaign dialog on a television screen for acquiring coupons or vouchers.

FIG. 7E exemplarily illustrates a use case describing a scenario where a consumer is targeted by the advertisement management platform to engage in an advertisement campaign dialog on a mobile wallet application deployed on a mobile consumer device or a web browser for acquiring coupons or vouchers.

FIG. 7F exemplarily illustrates a use case describing a scenario where a consumer redeems a coupon or voucher at a retail point of sale using the mobile wallet application.

### DETAILED DESCRIPTION OF THE INVENTION

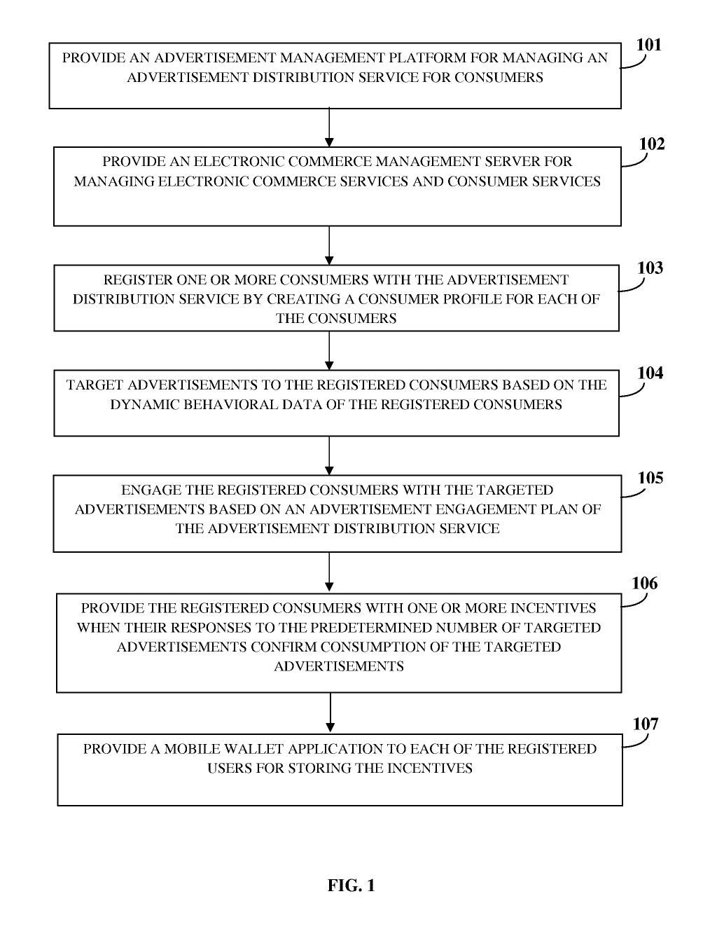

FIG. 1 illustrates a computer implemented method for managing advertisements, electronic commerce, and consumer services. An advertisement management platform comprising at least one processor configured to manage an advertisement distribution service for multiple consumers is provided 101. As used herein, the term “advertisement distribution service” refers to a service provided by the advertisement management platform for acquiring advertisement media from retailers, advertisers, and marketing and branding entities, performing targeted distribution of the advertisements to consumers, integrating targeted advertising with consumer-beneficial electronic commerce and consumer services and incentives to retain the interest of the consumers, etc. In an embodiment, an electronic commerce management server configured to communicate with the advertisement management platform, is provided 102. The electronic commerce management server comprises at least one processor configured to manage electronic commerce services and consumer services, for example, subsidized mobile services. The advertisement management platform registers 103 one or more consumers with the advertisement distribution service by creating a consumer profile for each of those consumers. The consumer profile comprises dynamic behavioral data of each of the registered consumers. For example, the dynamic behavioral data of each of the registered consumers comprises psychographic and demographic data provided during registration or sign up for the advertisement distribution service, and data generated from every advertisement engagement of the registered consumer and every voucher or coupon engagement of the registered consumer. Prior to initiation of the advertisement distribution service, the consumers may be required to answer an array of demographic and psychographic profiling questions before their services commence. This survey, along with accumulated and synthesized behavioral data is used to target specific advertisements and offers to the targeted consumers on an individual basis.

The advertisement management platform targets 104 advertisements to the registered consumers based on the dynamic behavioral data of the registered consumers through one or more of multiple media and communication channels. Targeted advertising is delivered over multiple media and communication channels comprising, for example, fixed and mobile voice networks, an unstructured supplementary service data (USSD) channel, wireless application protocol (WAP) or mobile web browsers, short message services (SMS), multimedia messaging services (MMS), the internet, internet web portals, digital television, automated teller machine (ATM) screens and other multimedia, where available. The advertisement management platform engages 105 the registered consumers with the targeted advertisements based on an advertisement engagement plan of the advertisement distribution service. As used herein, each “advertisement engagement” refers to the requirement of the consumer to respond to the advertisement after consumption such that the response indicates or confirms the consumption of the advertisement. The advertisement engagement plan requires each of the registered consumers to consume and provide a response to a predetermined number of targeted advertisements within a predetermined time period. For example, as part of the advertisement engagement plan, the consumers are required to engage with a certain number of advertisements per day. The advertisement management platform provides 106 the registered consumers with one or more incentives, for example, coupons, vouchers, electronic currency, etc., when their responses to one or more of the predetermined number of targeted advertisements confirm consumption of the targeted advertisements.

In an embodiment, an electronic mobile wallet application executable by at least one processor is provided 107 to each of the registered consumers for electronically storing the incentives, also herein referred to as coupons and/or electronic currency. The mobile wallet application is accessible through a wide spectrum of technologies and devices, for example, a general packet radio service (GPRS), 3G, a short message service (SMS) or multimedia messaging service (MMS) message communication, a voice over internet protocol (VOIP) voice or data communication, or other internet enabled cellular phones and tablet computing devices, computers with connection to the internet, televisions with digital set top boxes, etc. The mobile wallet application is accessible on a consumer device, for example, a personal computer, a laptop, a mobile phone such as the iPhone® of Apple Inc., a personal digital assistant, a tablet computing device such as the iPad® of Apple Inc., a global system for mobile communications (GSM) or a code division multiple access (CDMA) communication device that utilizes an unstructured supplementary service data (USSD) or a wireless application protocol (WAP) browser, or a mobile web browser for communicating with the advertisement management platform, a television with a digital set top box, a game console such as the PlayStation® of Sony Corporation, the Xbox® of Microsoft Corporation, the Nintendo® Wii®, other communication devices, etc. The USSD protocol enables the consumer to perform fast data and low cost browsing on the GSM or CDMA communication device. The mobile wallet application is also accessible, for example, through a web browser, for example, a WAP browser or a mobile web browser on the consumer device via a network, for example, the internet, an intranet, a local area network (LAN), a wide area network (WAN), a communication network that implements Wi-Fi® of the Wireless Ethernet Compatibility Alliance, Inc., a cellular network, a mobile communication network, a mobile wireless network, etc. The consumer may access and engage with the advertisements via the WAP browser or the mobile web browser of the GSM or CDMA communication device. The mobile wallet application enables exchange of the coupons and the electronic currency for retail transactions using the electronic commerce management server.

In an embodiment, each targeted advertisement has a unique question or query that is appended to the end of the targeted advertisement copy. The targeted advertisement requires the consumer to engage with the advertisement, which, for example, could be a forced engagement that may not be bypassed by the consumer. Every advertisement is individually targeted based on the individual consumer profiles. Each voucher or coupon offer may also be individually targeted based on the individual consumer profiles. The advertisement management platform updates each consumer profile by capturing behavioral data, for example, psychographic and demographic data during the service registration or sign up, from every previous advertisement engagement of the consumer, and from every previous voucher or coupon engagement of the consumer. The data on every advertisement and voucher or coupon campaign is tracked for the advertisers down to individual consumer profiles. The advertisements, coupons, and vouchers are delivered over different communication networks and media channels comprising, for example, mobile networks, the internet, television, and other media.

The mobile wallet application enables redemption of the incentives, for example, the coupons stored in the mobile wallet application for retail transactions at a point of sale, redemption of electronic cash for physical cash at a point of sale, and redemption of the incentives, for example, the coupons, electronic currency, etc., for purchasing airtime credit for mobile phone services at a point of sale. The information on one or more of the incentives, for example, the coupons, such as a coupon number or an offer code stored by the mobile wallet application is captured at a point of sale system in response to a request to redeem the stored coupons from the registered consumers. The point of sale system transmits the captured information to the advertisement management platform, in real time, for validating the stored coupons and enabling redemption of the stored coupons for the retail transactions. The electronic commerce management server removes the stored coupons from the mobile wallet application after the redemption of the stored coupons at the point of sale. The electronic commerce management server tracks the exchange of the coupons and the electronic currency for retail transactions and stores the tracked information in a central data warehouse. In an embodiment, the mobile wallet application converts the electronic currency received as one or more of the incentives to equivalent airtime credit for mobile phone services and vice versa.

In an embodiment, the registered consumers are engaged with transactions of the coupons based on an incentive engagement plan of the advertisement distribution service. The incentive engagement plan requires each of the registered consumers to accept and redeem a predetermined number of incentives, for example coupons within a predetermined time period. For example, as part of the incentive engagement plan, the consumers are required to accept a certain number of coupons or vouchers per week. In addition, the consumers are also required to redeem a certain number of coupons or vouchers every week or every month, which may vary from week to week.

The advertisement management platform maintains the dynamic behavioral data of each of the registered consumers in the central data warehouse. The advertisement management platform regularly updates the dynamic behavioral data in the data warehouse for each engagement of the registered consumers with the targeted advertisements and each exchange of the incentives, for example, the coupons and the electronic currency for retail transactions. All usage data of the consumers are stored in the data warehouse. The data warehouse serves as a master catalog of all individual consumer behavioral and psychographic data, service interactions or responses of the consumer with targeted advertisements, coupon or voucher receipts, retail store coupon or voucher redemptions, all mobile wallet transactions including loyalty program transactions, etc. The data warehouse generates individual and collective consumer analytics information, for example, based on the usage data of the consumers, the tracked information on the exchange of coupons and electronic currency, the dynamic behavioral data of the consumers, etc.

In an embodiment, an analytics engine executable by at least one processor in the data warehouse proactively generates consumer analytics information using, for example, one or more of the consumer profile of each of the consumers, information on advertisement engagements and coupon engagements, and the tracked information of the exchange of the coupons and electronic currency by the registered consumers for retail transactions. The advertisement management platform selectively provides the generated consumer analytics information, for example, to one or more retailers, advertisers, and marketing and branding service providers. The consumer analytics may be used by the retailers, the advertisers, and the marketing and branding service providers to develop their advertisement campaigns based on the consumer analytics information. The consumer analytics information is made available to retailers and other advertising clients to allow them to develop their advertisement campaigns. The retailers and marketing and branding entities may optimize their market strategy with real time campaign information available in each consumer profile from the data warehouse.

In an embodiment, the mobile wallet application enables conversion of electronic currency to equivalent airtime credit for mobile phone services and vice versa. The electronic commerce management server, in conjunction with the mobile wallet application, also provides support for additional electronic commerce services comprising, for example, loyalty programs, retail transactions, etc. In an embodiment, the virtual electronic currency is offered to the consumers as an incentive for completing a survey or a poll, and as a unit for loyalty points as part of a loyalty program.

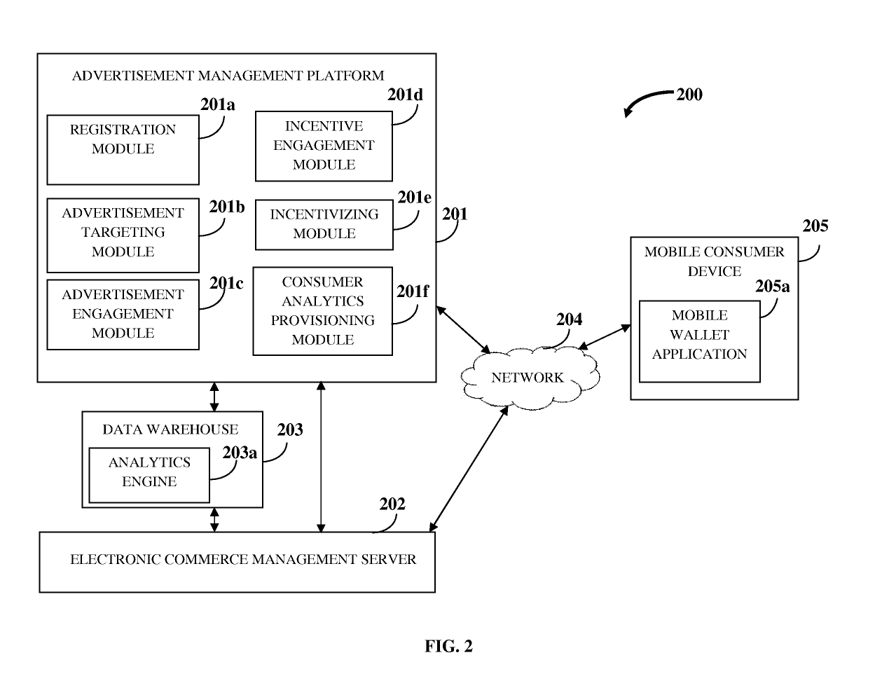

FIG. 2 illustrates a computer implemented system 200 for managing advertisements, electronic commerce, and consumer services. The computer implemented system 200 disclosed herein comprises an advertisement management platform 201, an electronic commerce management server 202, a mobile wallet application 205a provided on a consumer device 205 of the consumer, and a centralized data warehouse 203. The advertisement management platform 201 comprises at least one processor configured to execute the modules 201a, 201b, 201c, 201d, 201e, and 201f of the advertisement management platform 201. The components 201, 202, 205a, and 203 of the computer implemented system 200 disclosed herein communicate with each other over a network 204. The network 204 is, for example, the internet, an intranet, a local area network (LAN), a wide area network (WAN), a communication network that implements Wi-Fi® of the Wireless Ethernet Compatibility Alliance, Inc., a cellular network, a mobile communication network, etc. The consumer device 205 is, for example, a personal computer, a laptop, a mobile phone such as the iPhone® of Apple Inc., a personal digital assistant, a tablet computing device such as the iPad® of Apple Inc., a global system for mobile communications (GSM) communication device or a code division multiple access (CDMA) communication device that utilizes unstructured supplementary service data (USSD), a wireless application protocol (WAP) browser or a mobile web browser for communicating with the advertisement management platform 201, a television with a digital set top box, a game console such as the PlayStation® of Sony Corporation, the Xbox® of Microsoft Corporation, the Nintendo® Wii®, other communication devices, etc.

The advertisement management platform 201 manages the advertisement distribution service for the consumers. The advertisement management platform 201 comprises a registration module 201a, an advertisement targeting module 201b, an advertisement engagement module 201c, an incentive engagement module 201d, an incentivizing module 201e, and a consumer analytics provisioning module 201f. The registration module 201a registers one or more of the consumers with the advertisement distribution service by creating a consumer profile for each of those consumers. The consumer profile comprises dynamic behavioral data of each of the registered consumers. The advertisement targeting module 201b targets advertisements to the registered consumers based on the dynamic behavioral data of the registered consumers through one or more of multiple media and communication channels.

The advertisement engagement module 201c engages the registered consumers with the targeted advertisements based on an advertisement engagement plan of the advertisement distribution service. The advertisement engagement plan requires each of the registered consumers to consume and provide a response to a predetermined number of targeted advertisements within a predetermined time period. The incentivizing module 201e incentivizes the registered consumers, that is, provides the registered consumers with one or more incentives, for example, one or more coupons and/or electronic currency when the response to one or more of the predetermined number of targeted advertisements confirms consumption of the targeted advertisements. The incentive engagement module 201d engages the registered consumers with transactions associated with the incentives based on the incentive engagement plan of the advertisement distribution service. The incentive engagement plan requires each of the registered consumers to accept and redeem a predetermined number of incentives, for example, coupons within a time period.

The advertisement management platform 201 is associated with a data warehouse 203 that maintains the dynamic behavioral data of each of the registered consumers. The data warehouse 203 updates the dynamic behavioral data regularly for each engagement of the registered consumers with the targeted advertisements and for each exchange of the incentives, for example, the coupons and the electronic currency for retail transactions. The computer implemented system 200 disclosed herein further comprises an analytics engine 203a, for example, in the data warehouse 203. The analytics engine 203a is executable by at least one processor for proactively generating consumer analytics information, for example, based on the dynamic behavioral data of the registered consumers, the advertisement and coupon engagements of the registered consumers, and tracked information on the exchange of the incentives, for example, the coupons and electronic currency for retail transactions.

The consumer analytics provisioning module 201f associated with the advertisement management platform 201 selectively provides consumer analytics and consumer information, for example, to one or more retailers, advertisers, and marketing and branding service providers. The consumer information comprises, for example, the consumer profile of each of the registered consumers, information on the advertisement and coupon engagements of the consumer, and the tracked information for the exchange of the coupons and electronic currency for retail transactions. The retailers, the advertisers, and the marketing and branding service providers may develop advertisement campaigns based on the consumer analytics. In an embodiment, the analytics engine 203a implements predictive analytics for predictively determining results of the advertisement campaigns and for predicting system utilization for advertising, incentive transmissions, and incentive redemptions for each of the advertisement campaigns.

The electronic commerce management server 202 is configured to communicate with the advertisement management platform 201. The electronic commerce management server 202 comprises at least one processor configured to manage electronic commerce services and consumer services for the consumers. The electronic commerce management server 202 communicates with the data warehouse 203 for tracking the exchange of the incentives, for example, the coupons and electronic currency for retail transactions and storing information on the tracking in the data warehouse 203. The electronic commerce management server 202 in conjunction with the mobile wallet application 205a provides additional electronic commerce services comprising, for example, loyalty programs and retail transactions.

The mobile wallet application 205a is configured to communicate with the advertisement management platform 201. The mobile wallet application 205a executable by at least one processor is provided to each of the registered consumers for storing the incentives, for example, the coupons and the electronic currency. The mobile wallet application 205a, in communication with the electronic commerce management server 202, enables the exchange of the incentives for the retail transactions at a point of sale. The mobile wallet application 205a, in communication with the electronic commerce management server 202, enables redemption of the coupons for goods and services at retail establishments and for purchasing airtime credit for mobile phone services.

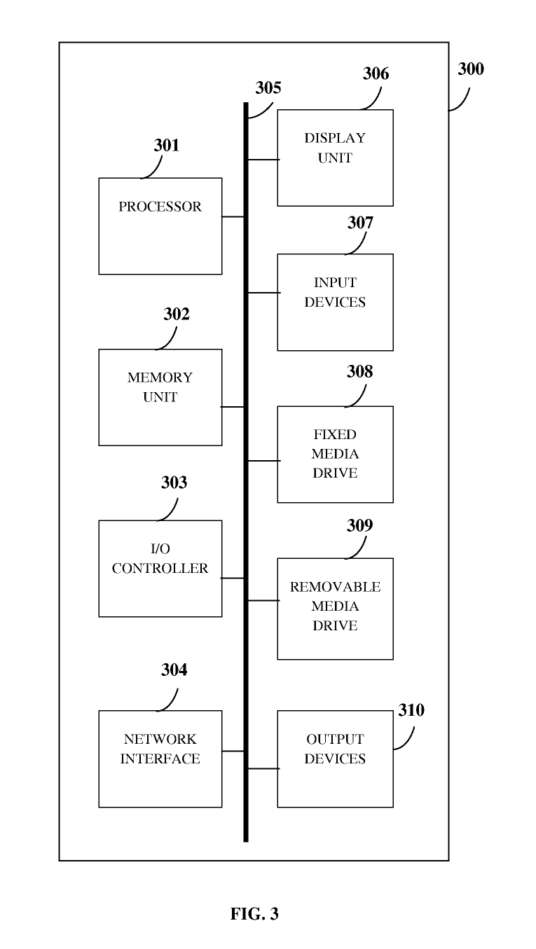

FIG. 3 exemplarily illustrates the architecture of a computer system 300 employed by the advertisement management platform 201, the electronic commerce management server 202, and/or the consumer device 205 comprising the mobile wallet application 205a exemplarily illustrated in FIG. 2, for managing advertisements, electronic commerce, and consumer services. The computer system 300 comprises, for example, a processor 301, a memory unit 302 for storing programs and data, an input/output (I/O) controller 303, a network interface 304, a data bus 305, a display unit 306, input devices 307, a fixed media drive 308, a removable media drive 309 for receiving removable media, output devices 310, etc.

The processor 301 is an electronic circuit that executes computer programs. The memory unit 302 stores programs, applications, and data. For example, the registration module 201a, the advertisement targeting module 201b, the advertisement engagement module 201c, the incentive engagement module 201d, the incentivizing module 201e, and the consumer analytics provisioning module 201f of the advertisement management platform 201 are stored in the memory unit 302 of the computer system 300 of the advertisement management platform 201. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301.

The network interface 304 enables connection of the computer system 300 to the network 204. The network 204 is, for example, a local area network (LAN), a wide area network, a mobile communication network, etc. The computer system 300 of each of the advertisement management platform 201 and the electronic commerce management server 202 communicates, for example, with the mobile wallet application 205a through the network interface 304. The network interface 304 comprises, for example, an infrared (IR) interface, a radio frequency (RF) interface, an interface that implements Wi-Fi® of the Wireless Ethernet Compatibility Alliance, Inc., a universal serial bus interface (USB), a local area network (LAN), a wide area network (WAN) interface, etc. The I/O controller 303 controls the input and output actions performed, for example, by administrators of the advertisement management platform 201 or the consumer using the consumer device 205. The data bus 305 permits communication between the modules, for example, 201a, 201b, 201c, 201d, 201e, and 201f of the advertisement management platform 201.

The display unit 306 of the consumer device 205 displays the actions computed by the mobile wallet application 205a to the consumer. For example, the display unit 306 of the consumer device 205 displays the advertisements targeted to the registered consumers by the advertisement management platform 201 based on the dynamic behavioral data of the registered consumers. The input devices 307 are used for inputting data into the computer system 300. The input devices 307 are, for example, a keyboard such as an alphanumeric keyboard, a joystick, a pointing device such as a computer mouse, a touch pad, a light pen, etc. The output devices 310 output the results of the operations computed by the mobile wallet application 205a, for example, to the consumer using the consumer device 205.

Computer applications and programs are used for operating the computer system 300. The programs are loaded onto the fixed media drive 308 and into the memory unit 302 of the computer system 300 via the removable media drive 309. In an embodiment, the computer applications and programs may be loaded directly via the network 204. Computer applications and programs are executed by double clicking a related icon displayed on the display unit 306 using one of the input devices 307.

The computer system 300 of each of the advertisement management platform 201, the electronic commerce management server 202, and the consumer device 205 employs an operating system for performing multiple tasks. The operating system is responsible for management and coordination of activities and sharing of resources of the computer system 300. The operating system further manages security of the computer system 300, peripheral devices connected to the computer system 300, and network connections. The operating system recognizes, for example, inputs provided by the consumer or an administrator using one of the input devices 307, output display, files, and directories stored locally on the fixed media drive 308. The operating system on the computer system 300 executes different programs, for example, a web browser, an electronic mail (email) application, etc., initiated by the consumer through the consumer device 205, using the processor 301. The operating system monitors the use of the processor 301. The processor 301 retrieves the instructions for executing the modules, for example, 201a, 201b, 201c, 201d, 201e, and 201f of the advertisement management platform 201, and the mobile wallet application 205a of the consumer device 205 from the program memory in the form of signals. A program counter determines the location of the instructions in the program memory. The program counter stores a number that identifies the current position in the program of the modules, for example, 201a, 201b, 201c, 201d, 201e, and 201f of the advertisement management platform 201 and the mobile wallet application 205a of the consumer device 205.

The instructions fetched by the processor 301 from the program memory after being processed are decoded. The instructions are placed in an instruction register (IR) in the processor 301. After processing and decoding, the processor 301 executes the instructions. For example, the registration module 201a defines instructions for registering one or more consumers with the advertisement distribution service by creating a consumer profile for each of those consumers. The advertisement targeting module 201b defines instructions for targeting advertisements to the registered consumers based on the dynamic behavioral data of the registered consumers through one or more of multiple media and communication channels. The advertisement engagement module 201c defines instructions for engaging the registered consumers with targeted advertisements based on the advertisement engagement plan of the advertisement distribution service. The incentivizing module 201e defines instructions for providing the registered consumers with one or more incentives, for example, coupons and electronic currency when a response to one or more of the predetermined number of targeted advertisements confirms consumption of the targeted advertisements. The incentive engagement module 201d defines instructions for engaging the registered consumers with transactions associated with the incentives, for example, coupons based on the incentive engagement plan of the advertisement distribution service. The consumer analytics provisioning module 201f defines instructions for selectively providing consumer analytics information, for example, the consumer profile of each of the registered consumers, information on advertisement and coupon engagements, and tracked information of the exchange of the coupons and electronic currency for retail transactions, to one or more retailers, advertisers, and marketing and branding service providers. The mobile wallet application 205a defines instructions for storing incentives, for example, the coupons and the electronic currency and for enabling exchange of the coupons and the electronic currency for retail transactions using the electronic commerce management server 202.

The data warehouse 203 associated with the advertisement management platform 201 defines instructions for maintaining the dynamic behavioral data of each of the registered consumers and updating the dynamic behavioral data regularly for each engagement of the registered consumers with the targeted advertisements and for each exchange of the incentives, for example, the coupons and the electronic currency for retail transactions. The analytics engine 203a defines instructions for proactively generating consumer analytics information, for example, based on the dynamic behavioral data of the registered consumers, the advertisement and coupon engagements of the registered consumers, and tracked information on the exchange of the incentives, for example, the coupons and electronic currency for retail transactions. Furthermore, the analytics engine 203a defines instructions for predictively determining results of the advertisement campaigns and for predicting system utilization for advertising, incentive transmissions, and incentive redemptions for each of the advertisement campaigns.

The processor 301 of the advertisement management platform 201 retrieves the instructions defined by the registration module 201a, the advertisement targeting module 201b, the advertisement engagement module 201c, the incentive engagement module 201d, the incentivizing module 201e, the data warehouse 203, the analytics engine 203a, and the consumer analytics provisioning module 201f, and executes the instructions. The processor 301 of the consumer device 205 retrieves the instructions defined, for example, by the mobile wallet application 205a and executes the instructions.

At the time of execution, the instructions stored in the instruction register are examined to determine the operations to be performed. The operations comprise arithmetic operations and logic operations. The processor 301 then performs the specified operations. The operating system performs multiple routines for performing a number of tasks required to assign the input devices 307, the output devices 310, and memory for execution of the modules, for example, 201a, 201b, 201c, 201d, 201e, 201f, and 205a of the advertisement management platform 201 and the consumer device 205 respectively. The tasks performed by the operating system comprise assigning memory to the modules, for example, 201a, 201b, 201c, 201d, 201e, 201f, and 205a of the advertisement management platform 201 and the consumer device 205 respectively, moving data between the memory unit 302 and disk units, and handling input/output operations. The operating system performs the tasks on request by the operations and after performing the tasks, the operating system transfers the execution control back to the processor 301. The processor 301 continues the execution to obtain one or more outputs. The outputs of the execution of the modules, for example, 201a, 201b, 201c, 201d, 201e, 201f, and 205a of the advertisement management platform 201 and the consumer device 205 respectively are displayed, for example, to the administrators of the advertisement management platform 201 and the consumer using the consumer device 205 respectively.

Disclosed herein is also a computer program product comprising a non-transitory computer readable storage medium that stores computer program codes comprising instructions executable by at least one processor. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor 301, except for a transitory, propagating signal.

The computer program product disclosed herein comprises one or more computer program codes for managing advertisements, electronic commerce, and consumer services. For example, the computer program product disclosed herein comprises a first computer program code for registering one or more of the consumers with the advertisement distribution service by creating a consumer profile for each of those consumers; a second computer program code for targeting advertisements to the registered consumers based on the dynamic behavioral data of the registered consumers through one or more of multiple media and communication channels; a third computer program code for engaging the registered consumers with the targeted advertisements based on the advertisement engagement plan of the advertisement distribution service; and a fourth computer program code for providing the registered consumers with one or more incentives, for example, coupons and electronic currency when the response to one or more of the predetermined number of targeted advertisements confirms consumption of the targeted advertisements.

The computer program product disclosed herein further comprises, for example, a fifth computer program code for enabling exchange of the coupons and the electronic currency stored in the mobile wallet application 205a among the registered consumers and for retail transactions using the electronic commerce management server 202. The computer program product disclosed herein further comprises additional computer program codes for performing additional steps that may be required and contemplated for managing advertisements, electronic commerce and consumer services.

The computer program codes comprising the computer executable instructions for managing advertisements, electronic commerce and consumer services are embodied on the non-transitory computer readable storage medium. The processor 301 of the computer system 300 retrieves these computer executable instructions and executes them. When the processor 301 executes the computer executable instructions, the computer executable instructions cause the processor 301 to perform the method steps for managing advertisements, electronic commerce and consumer services. In an embodiment, a single piece of computer program code comprising computer executable instructions performs one or more steps of the computer implemented method disclosed herein for managing advertisements, electronic commerce and consumer services.

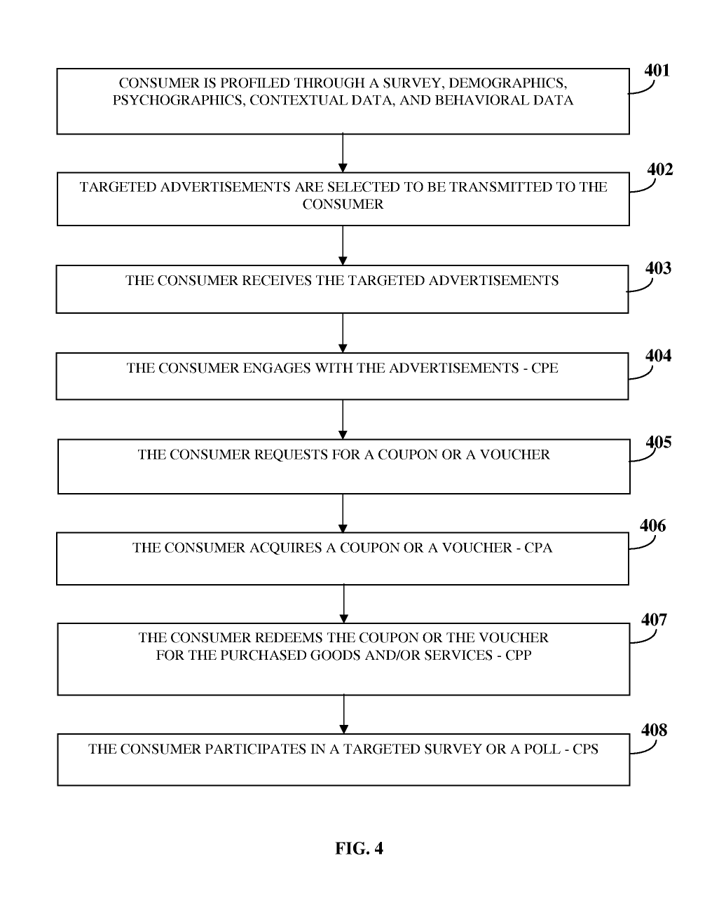

FIG. 4 exemplarily illustrates a flowchart comprising the steps for providing and utilizing the advertisement distribution service of the advertisement management platform 201 exemplarily illustrated in FIG. 2. The advertisement distribution service incorporates, for example, advertising to consumers using both visual and audio content through targeted advertising engagements referred to as cost per engagement (CPE); coupon or voucher distribution referred to as cost per acquisition (CPA); coupon or voucher redemption at retail locations referred to as cost per purchase (CPP); and a targeted survey or a poll referred to as cost per survey (CPS). A consumer is profiled 401 through an initial sign up survey during registration, demographics, psychographics, contextual data, and behavioral data. The advertisement management platform 201 selects 402 targeted advertisements to be transmitted to the consumer based on the consumer profile. The consumer receives 403 the targeted advertisements over different communication networks and media channels comprising, for example, an unstructured supplementary service (USSD) channel, wireless application protocol (WAP), mobile web, SMS, MMS, voice, the internet, television, etc. The consumer engages 404 with the advertisements following an advertisement engagement plan that stipulates that the consumer is required to engage with a predetermined number of advertisements within a predetermined time period. Each “advertisement engagement” refers to the requirement of the consumer to respond to the advertisement after consumption such that the response indicates or confirms the consumption of the advertisement. The consumer response may include a request 405 for a coupon or a voucher as an incentive for confirming the consumption of the advertisement. The consumer acquires 406 a coupon or a voucher and, in an embodiment, stores the coupon or the voucher in the mobile wallet application 205a on the consumer device 205. The consumer may then redeem 407 the coupon or the voucher for purchased goods and/or services, for example, via a USSD channel, WAP, mobile web, SMS, MMS, voice, the internet, television, etc. The consumer may also participate 408 in a targeted survey or a poll conducted by the advertisement management platform 201.

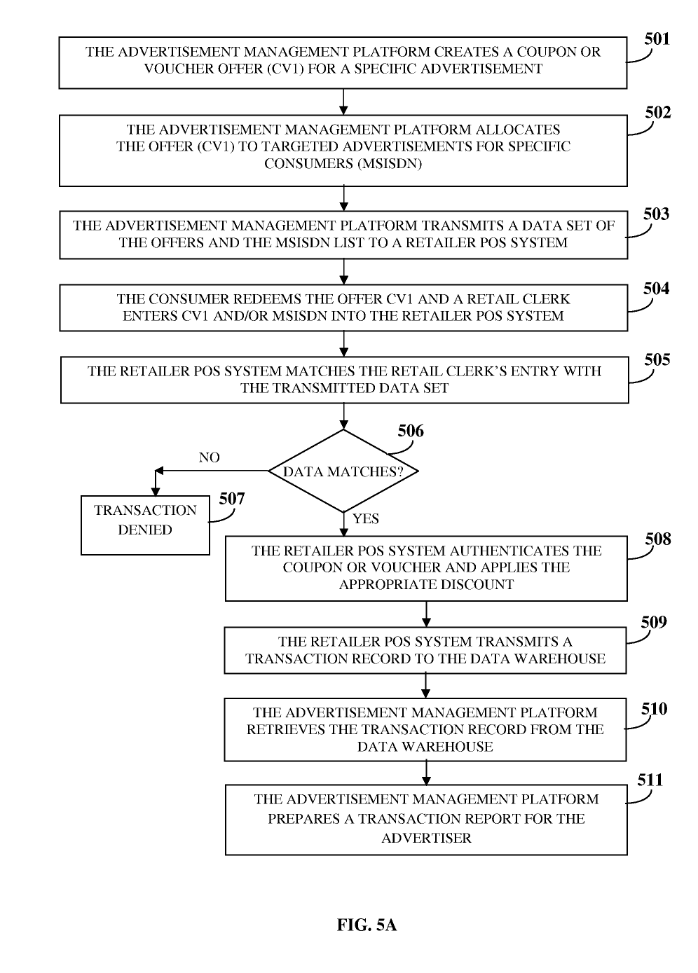

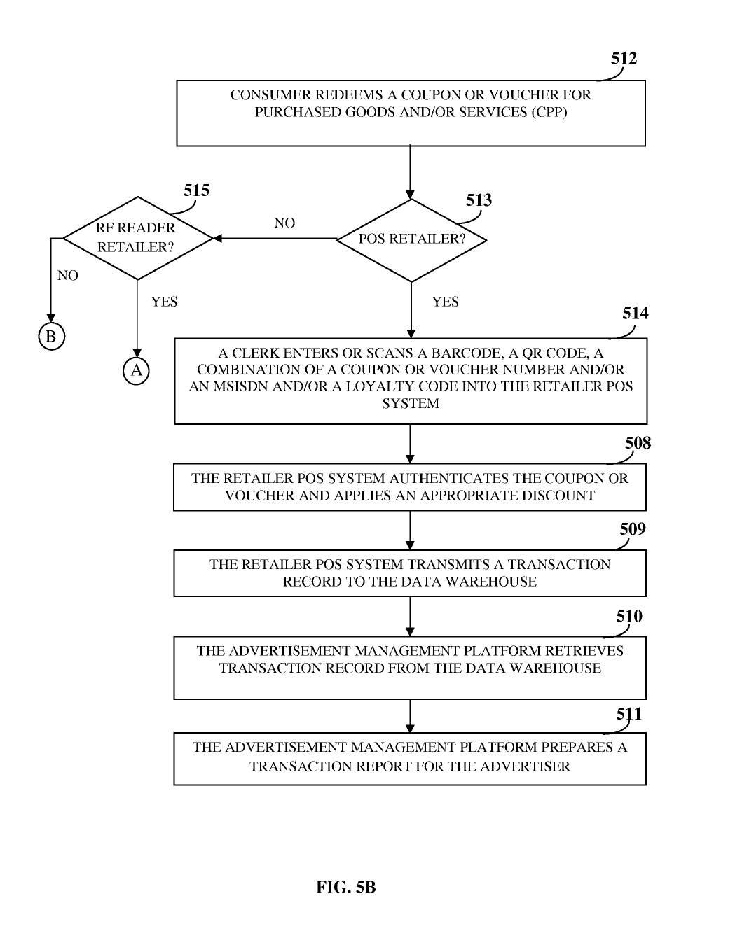

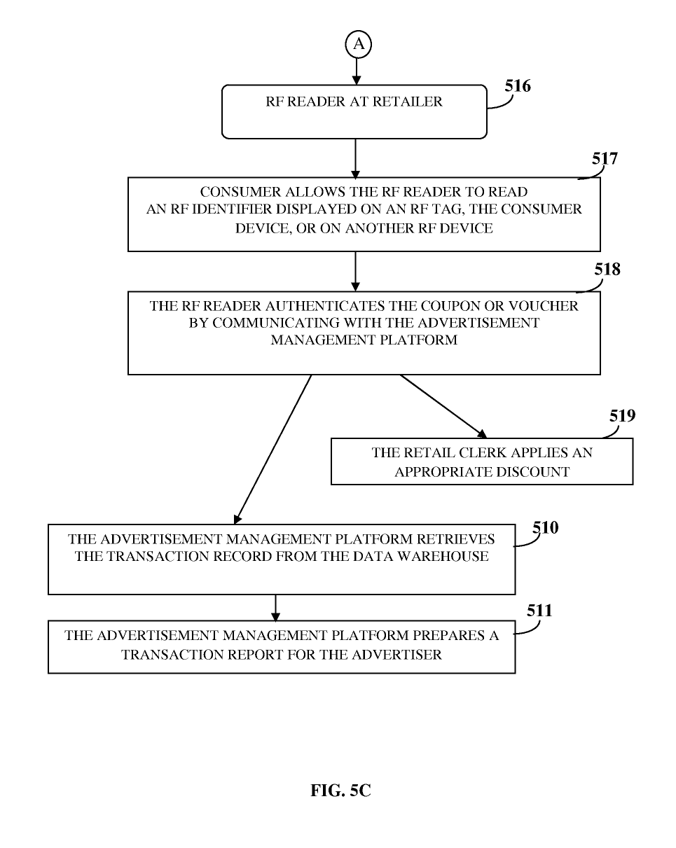

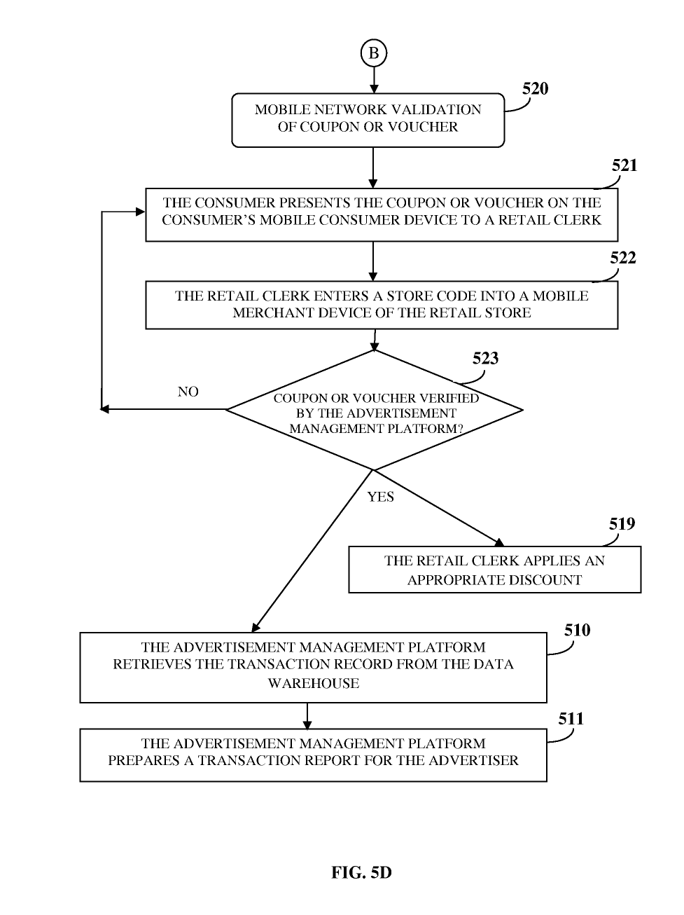

FIG. 5A exemplarily illustrates a flowchart of back end communication between the advertisement management platform 201, exemplarily illustrated in FIG. 2, and a point of sale (POS) for coupon or voucher redemptions. The advertisement management platform 201 creates 501 a coupon or voucher offer, for example, CV1, for a specific advertisement or advertisement campaign. The advertisement management platform 201 allocates 502 the offer CV1 to targeted advertisements for specific consumers, wherein each consumer is identified by a specific identifier, for example, the mobile subscriber integrated services digital network number (MSISDN) of the consumer device 205. The advertisement management platform 201 transmits 503 a data set comprising the offers and the MSISDN list to a retailer POS system. A consumer requests to redeem 504 the offer CV1 stored in the mobile wallet application 205a of the consumer device 205 at the POS, and a retail clerk enters 504 the offer code CV1 and/or the MSISDN of the consumer into the retailer POS system. The retailer POS system matches 505 the retail clerk's entry with the data set transmitted by the advertisement management platform 201. Depending on whether the offer code and/or the MSISDN entered matches 506 one or more entries of the data set, the transaction is either denied 507 or the coupon or voucher is authenticated 508. If the offer code and/or the MSISDN entered matches one or more entries of the data set, the retailer POS system authenticates 508 the coupon or voucher and applies 508 the appropriate discount for the purchased goods and/or services. The retailer POS system then transmits 509 a transaction record to the data warehouse 203 associated with the advertisement management platform 201 and the electronic commerce management server 202. The electronic commerce management server 202 removes the redeemed coupon or voucher from the mobile wallet application 205a. The advertisement management platform 201 retrieves 510 the transaction record from the data warehouse 203 and prepares 511 a transaction report for the advertiser.

FIG. 5B exemplarily illustrates a flowchart of a front end transaction at a point of sale (POS) for redeeming coupons or vouchers according to the computer implemented method and system 200 exemplarily illustrated in FIG. 2 disclosed herein. The consumer may request to redeem 512 a coupon or voucher acquired and stored, for example, in the mobile wallet application 205a on the consumer device 205 from the advertisement management platform 201. Depending on the retailer POS system 513, a clerk at the POS manually enters or scans 514, for example, a barcode, a quick redemption (QR) code, a combination of a coupon or voucher number and/or the MSISDN of the consumer and/or the loyalty code into the retailer POS system, or utilizes 515 a radio frequency (RF) reader as disclosed in the detailed description of FIG. 5C. The retailer POS system communicates with the advertisement management platform 201 to authenticate 508 the coupon or voucher and applies the appropriate discount for the purchased goods and/or services. The retailer POS system then transmits 509 a transaction record to the data warehouse 203 associated with the advertisement management platform 201 and the electronic commerce management server 202. The electronic commerce management server 202 removes the redeemed coupon or voucher from the mobile wallet application 205a. The advertisement management platform 201 retrieves 510 the transaction record from the data warehouse 203 and prepares 511 a transaction report for the advertiser.

FIG. 5C exemplarily illustrates a flowchart of a transaction at a point of sale (POS) having a radio frequency (RF) reader 516 for redeeming coupons or vouchers. The consumer allows 517 the RF reader to read an RF identifier displayed on an RF tag, a display screen of the consumer device 205 exemplarily illustrated in FIG. 2, or on another RF device to determine the coupon or voucher identification code. The RF reader authenticates 518 the coupon or voucher by communicating with the advertisement management platform 201. After authentication, the retail clerk applies 519 an appropriate discount for the purchased goods and services. The advertisement management platform 201 retrieves 510 the transaction record containing information of the current transaction from the data warehouse 203 and prepares 511 a transaction report for the advertiser.

FIG. 5D exemplarily illustrates a flowchart of a transaction at a point of sale (POS) that uses unstructured supplementary service data (USSD), a wireless application protocol (WAP) browser, a mobile web browser session or other similar real time sessions for validating a coupon or a voucher. The real time sessions may also be conducted over other communication protocols comprising SMS, MMS, WAP, mobile web, and other cellular communications. For conducting a mobile network validation 520 of the coupon or voucher, the consumer presents 521 the coupon or voucher on the consumer's mobile consumer device 205 exemplarily illustrated in FIG. 2, to a retail clerk. The retail clerk enters 522 a store code into a mobile merchant device of the retail store in the ongoing session. The advertisement management platform 201 verifies 523 the coupon or the voucher. After verification, the retail clerk applies 519 an appropriate discount for the purchased goods and services. The advertisement management platform 201 retrieves 510 the transaction record containing information of the current transaction from the data warehouse 203 and prepares 511 a transaction report for the advertiser.

FIG. 6 exemplarily illustrates an embodiment of the advertisement distribution service, advertisement engagement, and coupon engagement of the advertisement management platform 201, exemplarily illustrated in FIG. 2, in association with a managed service organization (MSO). An MSO advertisement insertion and set top box (STB) middleware 601, herein referred to as the STB middleware 601, is provided in communication with the advertisement management platform 201. When a consumer registers for the advertisement distribution service with the MSO, the consumer may register through different options. In an example, the consumer selects channel 100 on a consumer television (TV) remote control 603 and uses the TV remote control 603 to sign up and register on-screen or calls a toll-free customer service number provided by the MSO to register for a new consumer account. Once the consumer completes a profile questionnaire of, for example, about ten to twenty questions during the on-screen interaction or provides responses to questions asked by a customer service phone representative, the consumer must agree to the opt-in terms of service (ToS). The advertisement management platform 201 then locks the set top box (STB) 602 to a specific channel, for example, channel 100, with a new password for the new consumer account.

The consumer then permits other household members to create their own sub-accounts with their own passwords following the same steps for a new registration. The consumer experience with the MSO minors what a consumer must do on the internet when the consumer logs on to a web account. After all the consumers in the household have registered, the consumer browses the program guide and selects programs, as the consumer would typically do with their TV remote control 603. Upon registration, the consumer receives a mobile wallet (m-wallet) application 205a used for redeeming coupons, that is sent to their mobile consumer device 205, for example, a smart phone or through electronic mail (email) for download, by the advertisement management platform 201 via the network 204. If the consumer does not possess a smart phone, the consumer is provided a mobile wallet account that the consumer can use with their standard mobile phone. The consumer's typical viewing experience remains unchanged with the exception that that the set top box channel number is fixed on a specific channel as determined by the MSO.

The advertisement engagement plan according to the embodiment of FIG. 6 provides advances in the consumer's experience. Firstly, the consumer is locked to a specific channel, for example, channel 100 on the set top box 602 and begins to receive advertisements at the normal advertisement interval times which have been specifically identified and targeted for that individual consumer. Each individual consumer will have a completely different advertising experience based on inter alia the dynamic behavioral data of the consumer. Secondly, each advertisement displays an advertisement question or offers a meta-tagged coupon, for example, on a lower third of the television screen. In an embodiment, this question may also be asked using a text-to-speech (TTS) engine at the same time for the visually impaired. Finally, the consumer uses the television remote control 603 to answer the question on the television screen. If the television remote control 603 is temporarily out of order or if the set top box 602 is not capable of a two-way interaction, the consumer can respond using the mobile wallet application 205a on the mobile consumer device 205.

Generally, a consumer only has to respond, for example, by pressing buttons corresponding to a selection “A” for Yes, “B” for No, or “C” for Ignore or other answer options to the questions on-screen, or by using a text-to-speech (TTS) engine in the mobile wallet application 205a. Each time the consumer interacts with a targeted advertisement or coupon offer, the consumer accrues loyalty points. When the consumer accrues a certain number of loyalty points, the consumer is rewarded, for example, with a product or a service from the MSO, the advertiser, or both. When the consumer takes the time to respond to an advertisement targeted to the consumer with any of the options “A”, “B” or “C”, the consumer accrues loyalty points just for responding to the advertisements. In an embodiment, more loyalty points are accrued for a positive response, for example, option “A” or “Yes” than for option “B” or “No” or other answer options, while fewer points are accrued for “C” or “Ignore/I don't know” response, which has the least point accrual value. The consumer may review and redeem their loyalty points using the mobile wallet application 205a. The loyalty point and rewards classification structure of the computer implemented method and system 200 disclosed herein is configured to meet the requirements of each MSO.

All consumer interactions are tracked, managed and analyzed by a predictive analytical algorithm implemented by the analytics engine 203a in the data warehouse 203 for advertising clients in real time. As used herein, the term “advertising clients” represent clients for the administrators of the advertisement management platform 201 and the electronic commerce management server 202, and comprise, for example, advertisers, retailers, and the marketing and branding service providers who seek to develop and implement advertisement campaigns by utilizing the advertisement management platform 201 of the computer implemented system 200 disclosed herein. The administrators of the advertisement management platform 201 and the electronic commerce management server 202 may provide services to the advertising clients for an appropriate remuneration or on a contract basis. In an embodiment, the consumer data is used to predict the result of a specific advertising campaign, prior to the launch of the advertising campaign. These predictive analytics are used both as a sales mechanism for demonstrating, in a strict analytic manner, the results an advertising client can expect from an advertising campaign, as well as a tool for predicting system utilization for advertising, coupon transmissions, and coupon redemptions from a specific advertising campaign. For example, if the advertising client contracts for 100,000 coupon redemptions, the analytics engine 203a predictively determines the number of advertisements that must be transmitted to a specific audience for achieving the goal of 100,000 coupon redemptions. Since the advertisement distribution service of the advertisement management platform 201 is related to the advertising results, the predictive analytical algorithm of the analytics engine 203a provides analytical insights into the expected results from a targeted advertising campaign.

The individual consumer data is available to the advertising clients on a per-campaign basis, for example, within about 24 hours of an advertisement campaign going live on television. Along with the feedback on the individual consumer responses to the targeted advertisements, the analytics or the results of the advertisement campaign are made available to the advertising clients anytime through the consumer analytics provisioning module 201f exemplarily illustrated in FIG. 2. These analytics comprising consumer targeting insight on the existing advertisement campaign are valuable to the advertising clients and allow them to effectively manage and target their existing and future advertisement campaigns.

When the consumer decides to redeem a coupon provided for an advertisement engagement through the set top box 602, the consumer automatically receives this coupon in their mobile wallet application 205a. When the consumer decides to redeem the coupon in a retail store, the consumer opens the mobile wallet application 205a, retrieves the coupon from a mobile wallet folder in the mobile wallet application 205a, and provides the coupon to a cashier at the check-out counter, where the cashier can scan the coupon into the retailer point of sale (POS) system 604. If the consumer does not possess a smart phone, the consumer retrieves the same coupon from their non-smart phone mobile wallet application 205a instead. In an embodiment, a list of earned coupons may be retrieved, for example, from an unstructured supplementary service data (USSD) or WAP or mobile web menu on the mobile wallet application 205a of the consumer device 205. The consumer selects a coupon from the list in the USSD or WAP or mobile web menu on the mobile wallet application 205a and shares its alphanumeric code with the cashier. The cashier then types this alphanumeric code into the retailer POS system 604 to redeem the coupon. The advertisement management platform 201 integrates with point of sale (POS) retail systems worldwide and settles the coupon dynamically in real time with the resident mobile wallet application 205a or the non-smart phone USSD or WAP or mobile web mobile wallet. The advertising client is then notified of all coupon conversions for a particular advertisement campaign in real time via the consumer analytics provisioning module 201f, which serves as an advertisement campaign tool for the advertising clients.

In an embodiment, the advertisement management platform 201 provides the consumer with a proprietary mobile wallet application 205a deployable on a mobile consumer device 205, for example, a smart phone, a global system for mobile communications (GSM) cellular phone or a code division multiple access (CDMA) cellular phone that utilizes unstructured supplementary service data (USSD), a WAP browser or a mobile web browser for communicating with the advertisement management platform 201, etc., for managing and redeeming coupons, points, rewards, other incentives, etc., for sending and/or receiving virtual cash, for coupon sharing with friends on social networking platforms such as Facebook®, Twitter®, etc. Consider an example where a consumer initiates registration for the advertisement distribution service using a smart phone, for example, the iPhone® of Apple Inc. The consumer may register through different options. For example, the consumer can download the smart phone mobile wallet application 205a from the Apple store of Apple Inc., an Android® applications store of Google, Inc., or another smart phone mobile or web application storefront, and follow the in-application steps via the smart phone. Alternatively, the consumer may access a dedicated web page of the advertisement management platform 201 using a web browser on the consumer device 205 via the network 204, for example, the internet and follow the steps for downloading the mobile wallet application 205a on the consumer device 205 and setting up a web mobile wallet account.

The consumer may also call a toll-free customer service number associated with the advertisement management platform 201 to register for the advertisement distribution service and have the mobile wallet application 205a sent to the consumer's smart phone. Once the consumer completes a profile questionnaire containing, for example, about five to ten questions during the in-application steps, on the web page, or on the phone interaction with a customer service representative, the consumer is requested to agree to the opt-in terms of service (ToS) of the advertisement management platform 201. On agreeing to the opt-in ToS, the consumer is officially registered with the advertisement distribution service provided by the advertisement management platform 201. The consumer experience with the smart phone mobile wallet application 205a minors what a consumer can do on the Internet when the consumer uses the web mobile wallet account. Upon registration, the consumer receives the smart phone mobile wallet application 205a sent, for example, to the consumer's smart phone or sent through electronic mail (email) for download. If the consumer does not possess a smart phone, the advertisement management platform 201 creates a mobile wallet account that the consumer can use with a standard consumer device 205 such as a mobile phone or their web account or web mobile wallet account.

The advertisement engagement plan according to the embodiment of the smart phone mobile wallet application 205a provides advances in consumer experience. For example, the consumer begins to receive advertisements at typical advertisement interval times, which have been specifically identified and targeted for that individual consumer by the advertisement management platform 201, even if the smart phone mobile wallet application 205a and the web page is not open on the consumer's smart phone. The advertisement management platform 201 provides each individual consumer with a different advertising experience from the next consumer. In another example, each advertisement displays an advertisement question on the consumer's smart phone. The advertisement question may appear, for example, as a pop-up question in the smart phone mobile wallet application 205a or the web browser. These advertisement questions may also appear, for example, as “growl” messages. Growl messages, supported by the Open Source group of The Growl Project, are notification messages supported by the Macintosh (MAC) operating system (OS) X of Apple Inc., and Microsoft Windows® of Microsoft Corporation. In an embodiment, the advertisement question may also be asked using a text-to-speech (TTS) engine at the same time for visually impaired consumers. The consumer then uses the smart phone mobile wallet application 205a or the web browser to provide a response to the question on the smart phone or web screen. If the smart phone mobile wallet application 205a or the web browser has no mobile network data or internet connection, the session is temporarily stored or cached in the consumer's smart phone and reappears when the mobile network data or the internet connection is reconnected.

The smart phone mobile wallet application 205a enables the consumer to enter a response to an advertisement question, for example, by pressing buttons corresponding to a selection “A” for “Yes” or another answer option, a selection “B” for “No” or another answer option, or a selection “C” for “Ignore” or another answer option on a screen of the consumer's smart phone, or through a text-to-speech (TTS) engine in the smart phone mobile wallet application 205a. Every time the consumer interacts with the targeted advertisement or coupon offer, the consumer generates loyalty points, which are automatically updated in their mobile wallet account. When the consumer accrues a certain number of loyalty points, the consumer is rewarded with a product or a service, for example, from a retailer, an advertiser, or a third party provider. When the consumer takes the time to respond to any targeted advertisement with any of the options “A”, “B” or “C”, the consumer accrues loyalty points just for responding to the advertisements. In an embodiment, more points are accrued for option “A” or “Yes” responses than for option “B” or “No” responses, while fewer points are accrued for “C” or “Ignore/I don't know” or another answer option responses which have the least point accrual value.

The consumer can review and redeem the loyalty points stored in the mobile wallet application 205a through the smart phone or the web browser. The loyalty point and rewards classification structure of the computer implemented method and system 200 disclosed herein is configured to the requirements of each smart phone. The consumer interactions are tracked, managed and analyzed by a predictive analytical algorithm implemented by the analytics engine 203a in the data warehouse 203 for advertising clients in real time. The individual consumer data is available on a per-campaign basis to a campaign advertiser, for example, within about 24 hours of an advertisement campaign becoming live in the smart phone mobile wallet application 205a or the web browser. Along with the feedback on the individual responses to the advertisement distribution service, the result of the advertisement campaign is made available to the advertising clients anytime through the consumer analytics provisioning module 201f. These analytics are valuable for providing consumer targeting insight on the existing campaign to allow the advertising clients to manage and target the advertiser's future campaigns.

When the consumer decides to redeem a coupon obtained by engaging with an advertisement on the smart phone mobile wallet application 205a or the web browser, the consumer automatically receives this coupon in their smart phone mobile wallet application 205a, in the web browser, or in the standard mobile wallet account. When the consumer decides to redeem the coupon in a retail store, the consumer invokes the smart phone mobile wallet application 205a, retrieves the coupon from a mobile wallet folder of the smart phone, and provides the coupon to a cashier at a check-out counter, where the cashier can scan the coupon into the retail point of sale (POS) system 604. When a consumer does not possess the smart phone mobile wallet application 205a, the consumer retrieves the same coupon from their non-smart phone mobile wallet application 205a. The consumer selects the coupon from the list in the USSD or WAP or mobile web mobile wallet menu and shares the alphanumeric code with the cashier. The cashier then types this alphanumeric code into the retailer POS system 604 to redeem the coupon. The advertisement management platform 201 integrates with point of sale (POS) retail systems worldwide and settles the coupon dynamically in real time with either the resident smart phone mobile wallet application 205a or the non-smart phone USSD or WAP or mobile web mobile wallet. When the retailer is not integrated with the advertisement management platform 201 or does not have the retailer POS system 604, the consumer can still redeem their barcode, quick redemption (QR) code or near field communication (NFC) based coupon at the retail store, directly from the smart phone mobile wallet application 205a. Typical phone consumers can obtain a retail rewards NFC card for an additional fee to use with these unsupported or non-POS retailers. The advertiser is notified of all coupon conversions for a particular campaign in real time via the advertisement campaign tool of the consumer analytics provisioning module 201f.

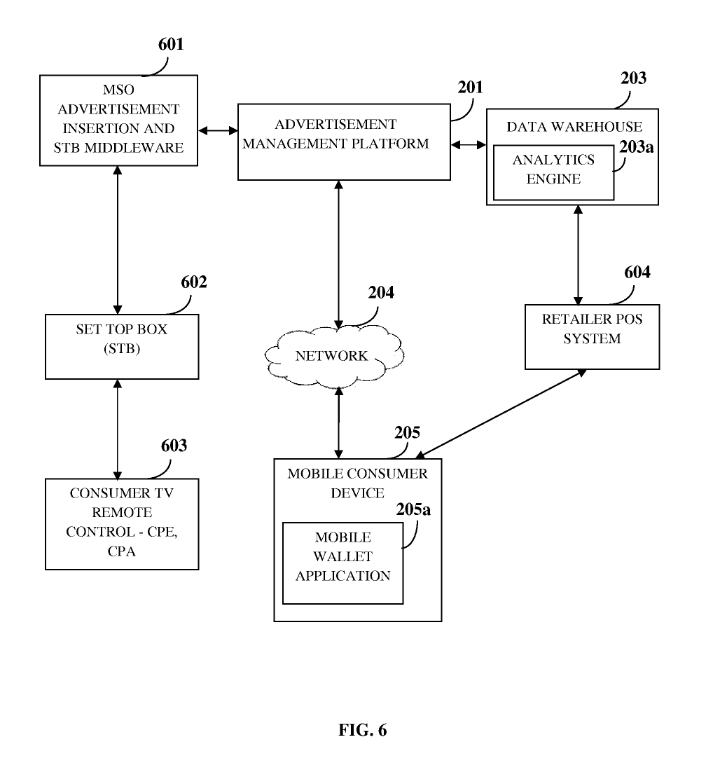

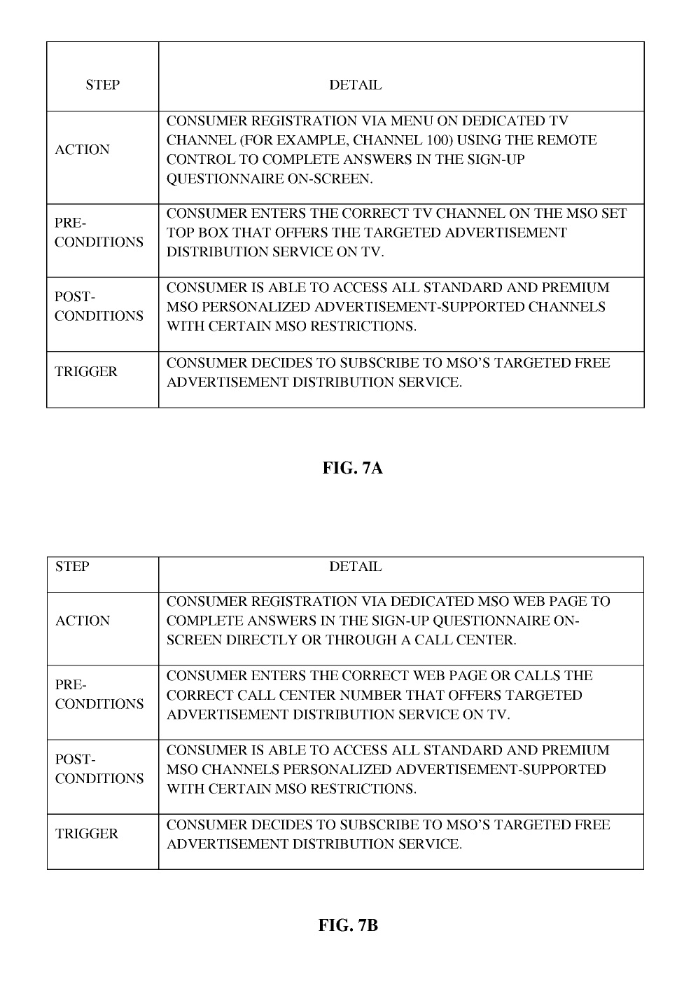

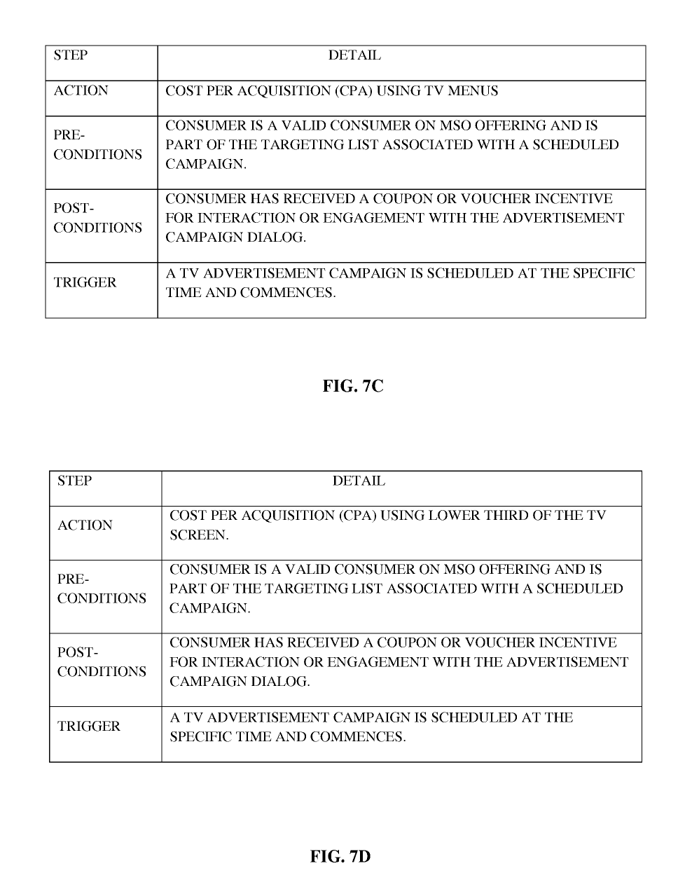

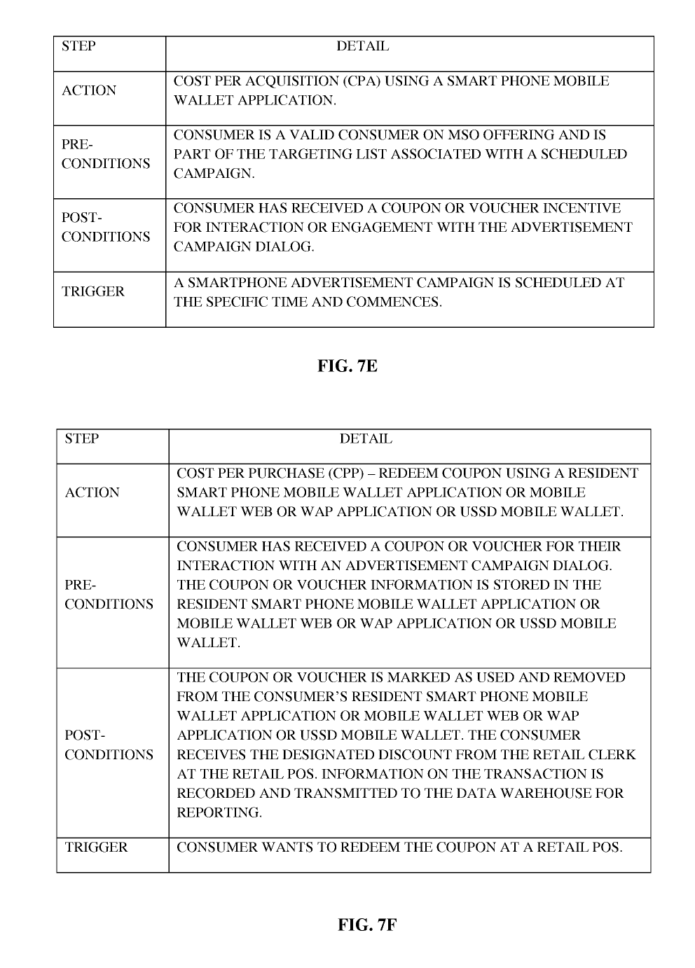

FIG. 7A exemplarily illustrates a use case describing consumer registration for the advertisement distribution service provided by the advertisement management platform 201 through a managed service organization (MSO) set top box (STB) 602, exemplarily illustrated in FIG. 6, on a television screen. When a consumer decides to subscribe to the MSO's targeted advertisement distribution service provided by the advertisement management platform 201, the consumer may enter a television (TV) channel on the MSO set top box 602 that offers the targeted advertisement distribution service on television, using a remote control 603. The advertisement management platform 201 registers the consumer with the advertisement distribution service via a television menu on the dedicated television (TV) channel, for example, channel 100 that is accessed by the consumer using the remote control 603 to complete answers in a sign-up questionnaire on-screen. If the consumer has an existing mobile subscriber integrated services digital network number (MSISDN), the advertisement management platform 201 collects and registers the MSISDN on the advertisement management platform 201. Alternatively, the consumer provides a validated electronic mail (email) address to the advertisement management platform 201, or the advertisement management platform 201 assigns a new MSISDN for the consumer device 205 of the consumer.

The advertisement management platform 201 captures consumer data, for example, through the STB middleware 601. The advertisement management platform 201 automatically enters the consumer data into a customer relationship management (CRM) application of the advertisement management platform 201. The consumer data is migrated into the data warehouse 203. After an email validation, the advertisement management platform 201 enables the advertisement distribution service for the consumer, thereby providing access to all standard and premium MSO personalized advertisement-supported channels with certain MSO restrictions. The advertisement management platform 201 also sends the mobile wallet application 205a for storing and managing coupons to the email address of the consumer and the consumer device 205, for example, as a hypertext markup language 5 (HTML5) web link, for the consumer to download.

If the consumer does not download the mobile wallet application 205a, the consumer can access the coupons, for example, through a USSD or WAP or mobile web based mobile wallet menu. The advertisement management platform 201 captures additional consumer information and interests during consumer interactions through the set top box 602 via the remote control 603 and updates the consumer profile of the consumer. The advertisement management platform 201 captures this consumer information within the customer relationship management application of the advertisement management platform 201 and eventually transmits this consumer information to the data warehouse 203 for reference. The consumer is then provisioned on the MSO network with a default advertisement-supported service plan. The consumer receives a confirmation email, and/or a USSD or SMS text confirmation of the new MSO service.

FIG. 7B exemplarily illustrates a use case describing consumer registration for the advertisement distribution service provided by the advertisement management platform 201 exemplarily illustrated in FIG. 6, through a managed service organization (MSO) using a web portal or a call center. When a consumer decides to subscribe to the MSO's targeted advertisement distribution service provided by the advertisement management platform 201, the consumer initiates registration via a dedicated MSO web page that offers the targeted advertisement distribution service on television directly, or by contacting a call center. The consumer enters a uniform resource locator (URL) of the MSO web page or calls the number of the call center using the consumer device 205, for example, a smart phone, a global system for mobile communications (GSM) cellular phone or a code division multiple access (CDMA) cellular phone that utilizes unstructured supplementary service data (USSD), a WAP browser, or a mobile web browser for communicating with the advertisement management platform 201, etc. The consumer or a MSO customer service representative (CSR) logs, for example, on to the dedicated web customer relationship management (CRM) application page to complete answers in a sign-up questionnaire. If the consumer has an existing mobile subscriber integrated services digital network number (MSISDN), the advertisement management platform 201 collects and registers the MSISDN on the advertisement management platform 201. Alternatively, the consumer provides a validated email address to the advertisement management platform 201, or the advertisement management platform 201 assigns a new MSISDN for the consumer device 205 of the consumer.

The consumer or the customer service representative (CSR) automatically enters consumer data into the customer relationship management (CRM) application of the advertisement management platform 201. The consumer data is migrated into the data warehouse 203. After an email validation, the advertisement distribution service is enabled for the consumer, which provides access to all standard and premium MSO personalized advertisement-supported channels with certain MSO restrictions. The advertisement management platform 201 sends the mobile wallet application 205a for storing and managing coupons to the email address of the consumer and the consumer device 205 for the consumer to download. If the consumer does not download the mobile wallet application 205a, the consumer can access the coupons through the unstructured supplementary service data (USSD), WAP or mobile web based mobile wallet menu. The advertisement management platform 201 captures additional consumer information and interests during consumer interactions through the customer relationship management (CRM) application web page and then transmits this consumer information to the consumer profile in the data warehouse 203 for reference. The consumer is then provisioned on the MSO network with a default advertisement-supported service plan. The consumer receives a confirmation email, and/or a USSD or SMS text confirmation of the new MSO service.

FIG. 7C exemplarily illustrates a use case describing a scenario where a consumer is targeted by the advertisement management platform 201 exemplarily illustrated in FIG. 6, to engage in an advertisement campaign dialog through television menus for acquiring coupons or vouchers. The advertisement management platform 201 checks whether the consumer is a valid consumer on a managed service organization (MSO) offering and whether the consumer is part of a targeting list associated with a scheduled advertisement campaign. The consumer receives an initial delivery of a television based advertisement campaign dialog scheduled at a specific time, through the set top box 602. The consumer responds by engaging with the advertisement campaign dialog and selecting one of the presented options. If the consumer chooses to “Ignore” a coupon, the advertisement management platform 201 stores this response in the consumer profile of the consumer and the question is scheduled to be re-sent at a later time.

If the consumer chooses to “Review” the coupon, the advertisement campaign dialog continues until the advertisement campaign dialog reaches a point where an incentive or a reward is defined. For example, the incentive is a coupon or a voucher redeemable for a 10% discount on the consumer's next purchase at a specific store. The consumer then “Accepts” or “Rejects” the coupon and the advertisement management platform 201 stores the response in the consumer profile. The incentivizing module 201e, exemplarily illustrated in FIG. 2, requests a coupon or a voucher from the batch that was associated with this reward point when the dialog and advertisement campaign were created in the advertisement management platform 201. The incentivizing module 201e provides an available coupon or voucher to the consumer and marks the coupon or voucher as “Active”. In an embodiment, the advertisement management platform 201 transmits the coupon or voucher to the mobile wallet application 205a of the consumer. The advertisement management platform 201 concludes the advertisement campaign dialog when the consumer is informed, for example, via email, the mobile wallet application 205a, and/or the USSD text notification of the incentive or the reward that the consumer just received.

FIG. 7D exemplarily illustrates a use case describing a scenario where a consumer is targeted by the advertisement management platform 201 exemplarily illustrated in FIG. 6, to engage in an advertisement campaign dialog on a television screen for acquiring coupons or vouchers. Based on a television advertisement campaign scheduled for advertisement delivery at specific times, the consumer receives a delivery of a television based advertisement campaign dialog, for example, on a lower third of the television screen. The consumer receives the advertisements when the consumer is registered for the managed service organization (MSO) offering and is part of the targeting list associated with the scheduled campaign. The consumer receives a coupon or voucher incentive for interacting or engaging with the advertisement campaign dialog.

FIG. 7E exemplarily illustrates a use case describing a scenario where a consumer is targeted by the advertisement management platform 201 exemplarily illustrated in FIG. 6, to engage in an advertisement campaign dialog on the mobile wallet application 205a deployed on a mobile consumer device 205 or a web browser for acquiring coupons or vouchers. The mobile consumer device 205 is, for example, a smart phone, a global system for mobile communications (GSM) or a code division multiple access (CDMA) cellular phone that utilizes unstructured supplementary service data (USSD), a WAP browser, or a mobile web browser for communicating with the advertisement management platform 201, etc. Based on a smart phone advertisement campaign scheduled for advertisement delivery a few times or at specific times, the consumer receives a delivery of a smart phone based advertisement campaign dialog. The consumer receives the advertisements when the consumer is registered for the managed service organization (MSO) offering and is part of the targeting list associated with the scheduled campaign. The consumer receives a coupon or a voucher incentive as well as a specific loyalty point value for each coupon or voucher, in the smart phone mobile wallet application 205a for interacting or engaging with the advertisement campaign dialog.

FIG. 7F exemplarily illustrates a use case describing a scenario where a consumer redeems a coupon or a voucher at a retail point of sale (POS) using the mobile wallet application 205a exemplarily illustrated in FIG. 2. The consumer accesses the resident smart phone mobile wallet application 205a, or the mobile wallet web or WAP application, or an unstructured supplementary service data (USSD) mobile wallet menu and selects a mobile wallet folder option. The advertisement management platform 201 presents the consumer with a list of mobile wallet content items and selects the coupon or voucher that the consumer wishes to redeem. The consumer scans the selected coupon or voucher barcode or a quick redemption (QR) code displayed on the smart phone mobile wallet application 205a to a point of sale (POS) reader, or provides the selected coupon using the other methods disclosed herein. Alternatively, the consumer shows or provides a unique coupon identifier (ID) to a retail clerk at the retail POS. The retail clerk automatically or manually verifies that coupon or voucher is valid for redemption at the retail POS store. The advertisement management platform 201 performs processing of the post-conditions exemplarily illustrated in FIG. 7F. That is, the electronic commerce management server 202 marks and removes the coupon or voucher from the consumer's resident smart phone mobile wallet application 205a or mobile wallet web or WAP application or USSD mobile wallet. The consumer receives a designated discount from the retail clerk at the retail POS. The retail clerk provides a discounted product against a product stock keeping unit (SKU) and checks-out the consumer. The integrated retail POS system provider records the consumer transaction data and transmits the consumer transaction data to the data warehouse 203 for reporting. The consumer receives, for example, an unstructured supplementary service data (USSD) or a short message service (SMS) notification that the transaction was performed.

Consider another example, where a registered consumer acquires a coupon or a voucher from the advertisement management platform 201 for confirming consumption of one or more advertisements delivered to the consumer by the advertisement management platform 201. The coupon or voucher is stored in the mobile wallet application 205a of the consumer. Subsequently, when the consumer redeems that coupon or voucher at a retail establishment, the coupon or voucher is removed from the mobile wallet application 205a, since the coupon or voucher has been redeemed to make a purchase or to obtain a discount. The value of the coupon or voucher is either deducted from the check out total at the retailer cash register, or alternatively could be credited back to the mobile wallet application 205a in the form of additional airtime credit, virtual cash, and/or loyalty points.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor, or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes the main memory. Volatile media comprise, for example, a register memory, processor cache, a random access memory (RAM), etc. Transmission media comprise, for example, coaxial cables, copper wire and fiber optics, including the wires that constitute a system bus coupled to a processor. Common forms of computer readable media comprise, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, and digital signal processors or like devices. Typically, a processor receives instructions from a memory or like device, and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as an object code. The computer program product disclosed herein comprises computer executable instructions embodied in a non-transitory computer readable storage medium, wherein the computer program product comprises computer program codes for implementing the processes of various embodiments.

Where databases are described such as the data warehouse 203, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, IBM® processors, etc., that are adapted to communicate with the computer. Any number and type of machines may be in communication with the computer.

The foregoing examples have been provided merely for the purpose of explanation and are in no way to be construed as limiting of the invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for managing advertisements, comprising:
providing an advertisement management platform comprising at least one processor configured to manage an advertisement distribution service for consumers;
registering one or more of said consumers with said advertisement distribution service by said advertisement management platform by creating a consumer profile for each of said one or more of said consumers, wherein said consumer profile comprises dynamic behavioral data of said each of said one or more of said consumers;
targeting advertisements to said registered one or more consumers based on said dynamic behavioral data of said registered one or more consumers through one or more of a plurality of media and communication channels by said advertisement management platform;
engaging said registered one or more consumers with said targeted advertisements based on an advertisement engagement plan of said advertisement distribution service by said advertisement management platform, wherein said advertisement engagement plan requires each of said registered one or more consumers to consume and provide a response to a predetermined number of said targeted advertisements within a predetermined time period; and
providing said registered one or more consumers with one or more incentives when said response from said each of said registered one or more consumers to one or more of said predetermined number of said targeted advertisements confirms consumption of said targeted advertisements.

2. The computer implemented method of claim 1, further comprising engaging said registered one or more consumers with transactions associated with said one or more incentives based on an incentive engagement plan of said advertisement distribution service by said advertisement management platform, wherein said incentive engagement plan requires each of said registered one or more consumers to accept and redeem a predetermined number of said one or more incentives within a predetermined time period.

3. A computer implemented method for managing advertisements, electronic commerce, and consumer services, comprising:
providing an advertisement management platform comprising at least one processor configured to manage an advertisement distribution service for consumers;
providing an electronic commerce management server configured to communicate with said advertisement management platform, said electronic commerce management server comprising at least one processor configured to manage electronic commerce services and said consumer services;
registering one or more of said consumers with said advertisement distribution service by said advertisement management platform by creating a consumer profile for each of said one or more of said consumers, wherein said consumer profile comprises dynamic behavioral data of said each of said one or more of said consumers;
targeting advertisements to said registered one or more consumers based on said dynamic behavioral data of said registered one or more consumers through one or more of a plurality of media and communication channels by said advertisement management platform;
engaging said registered one or more consumers with said targeted advertisements based on an advertisement engagement plan of said advertisement distribution service by said advertisement management platform, wherein said advertisement engagement plan requires each of said registered one or more consumers to consume and provide a response to a predetermined number of said targeted advertisements within a predetermined time period;
providing said registered one or more consumers with one or more incentives when said response from said each of said registered one or more consumers to one or more of said predetermined number of said targeted advertisements confirms consumption of said targeted advertisements; and
providing a mobile wallet application executable by at least one processor to said each of said registered one or more consumers for storing said one or more incentives, wherein said mobile wallet application enables exchange of said one or more incentives for retail transactions using said electronic commerce management server.

4. The computer implemented method of claim 3, wherein said one or more incentives comprise one or more of coupons, vouchers, and electronic currency.

5. The computer implemented method of claim 3, wherein said advertisement management platform maintains said dynamic behavioral data of said each of said registered one or more consumers in a data warehouse, wherein said dynamic behavioral data is regularly updated in said data warehouse for each of said engagement of said registered one or more consumers with said targeted advertisements and said exchange of said one or more incentives for said retail transactions.

6. The computer implemented method of claim 3, further comprising redeeming said stored one or more incentives for said retail transactions at a point of sale using said mobile wallet application, comprising:
capturing information on one or more of said stored one or more incentives from said mobile wallet application at a point of sale system in response to a request to redeem said stored one or more incentives from said registered one or more consumers;
transmitting said captured information by said point of sale system to said advertisement management platform for validating said stored one or more incentives and enabling said redemption of said stored one or more incentives for said retail transactions; and
redeeming said stored one or more incentives for said retail transactions, wherein said electronic commerce management server removes said stored one or more incentives from said mobile wallet application on said redemption of said stored one or more incentives.

7. The computer implemented method of claim 3, wherein said electronic commerce management server tracks said exchange of said one or more incentives for said retail transactions and stores information on said tracking in a data warehouse.

8. The computer implemented method of claim 3, further comprising converting electronic currency received as said one or more incentives to equivalent airtime credit by said mobile wallet application for mobile phone services and vice versa.

9. The computer implemented method of claim 3, further comprising engaging said registered one or more consumers with transactions associated with said one or more incentives based on an incentive engagement plan of said advertisement distribution service by said advertisement management platform, wherein said incentive engagement plan requires each of said registered one or more consumers to accept and redeem a predetermined number of said one or more incentives within a predetermined time period.

10. The computer implemented method of claim 3, further comprising generating consumer analytics information based on one or more of:
said consumer profile of said each of said one or more of said consumers;
information on said engagement of said targeted advertisements and engagement of said one or more incentives of said registered one or more consumers; and
tracked information of said exchange of said one or more incentives by said registered one or more consumers for said retail transactions.

11. The computer implemented method of claim 10, wherein said consumer analytics information is selectively provided to one or more retailers, advertisers, and marketing and branding service providers, whereby said retailers, said advertisers, and said marketing and branding service providers develop advertisement campaigns based on said consumer analytics information.

12. The computer implemented method of claim 11, further comprising implementing predictive analytics for predictively determining results of said advertisement campaigns and for predicting system utilization for advertising, incentive transmissions, and incentive redemptions for each of said advertisement campaigns.

13. The computer implemented method of claim 3, wherein said media and communication channels comprise fixed cellular networks, mobile cellular networks, an unstructured supplementary service data channel, wireless application protocol browsers, mobile web browsers, short message services, multimedia messaging services, internet web portals, and digital television.

14. The computer implemented method of claim 3, wherein said mobile wallet application enables each of said registered one or more consumers to provide said response to said predetermined number of said targeted advertisements within said predetermined time period.

15. A computer implemented system for managing advertisements, electronic commerce, and consumer services, comprising:
an advertisement management platform that manages an advertisement distribution service for consumers, said advertisement management platform comprising at least one processor configured to execute modules of said advertisement management platform, said modules of said advertisement management platform comprising:
a registration module that registers one or more of said consumers with said advertisement distribution service by creating a consumer profile for each of said one or more of said consumers, wherein said consumer profile comprises dynamic behavioral data of said each of said one or more of said consumers;
an advertisement targeting module that targets advertisements to said registered one or more consumers based on said dynamic behavioral data of said registered one or more consumers through one or more of a plurality of media and communication channels;
an advertisement engagement module that engages said registered one or more consumers with said targeted advertisements based on an advertisement engagement plan of said advertisement distribution service, wherein said advertisement engagement plan requires each of said registered one or more consumers to consume and provide a response to a predetermined number of said targeted advertisements within a predetermined time period; and
an incentivizing module that provides said registered one or more consumers with one or more incentives when said response from said each of said registered one or more consumers to one or more of said predetermined number of said targeted advertisements confirms consumption of said targeted advertisements; and
a mobile wallet application executable by at least one processor, said mobile wallet application configured to communicate with said advertisement management platform, wherein said mobile wallet application is provided to said each of said registered one or more consumers for storing said one or more incentives, wherein said mobile wallet application enables exchange of said one or more incentives for retail transactions.

16. The computer implemented system of claim 15, wherein said modules of said advertisement management platform further comprise an incentive engagement module that engages said registered one or more consumers with transactions associated with said one or more incentives based on an incentive engagement plan of said advertisement distribution service, wherein said incentive engagement plan requires each of said registered one or more consumers to accept and redeem a predetermined number of said one or more incentives within a predetermined time period.

17. The computer implemented system of claim 15, further comprising a data warehouse associated with said advertisement management platform, wherein said data warehouse maintains said dynamic behavioral data of said each of said one or more registered one or more consumers and updates said dynamic behavioral data regularly for each of said engagement of said registered one or more consumers with said targeted advertisements and said exchange of said one or more incentives for said retail transactions.

18. The computer implemented system of claim 15, further comprising an electronic commerce management server configured to communicate with said advertisement management platform, said electronic commerce management server comprising at least one processor configured to manage electronic commerce services and said consumer services, wherein said mobile wallet application in communication with said electronic commerce management server enables said exchange of said one or more incentives for said retail transactions at a point of sale and for purchasing airtime credit for mobile phone services.

19. The computer implemented system of claim 18, wherein said electronic commerce management server provides said electronic commerce services comprising loyalty programs and said retail transactions.

20. The computer implemented system of claim 18, further comprising a data warehouse associated with said electronic commerce management server, wherein said electronic commerce management server tracks said exchange of said one or more incentives for said retail transactions and stores information on said tracking in said data warehouse.

21. The computer implemented system of claim 15, further comprising an analytics engine associated with said advertisement management platform, wherein said analytics engine is executable by at least one processor for generating consumer analytics information based on one or more of:
said consumer profile of said each of said one or more of said consumers;
information on said engagement of said targeted advertisements and engagement of said one or more incentives of said registered one or more consumers; and
tracked information of said exchange of said one or more incentives by said registered one or more consumers for said retail transactions.

22. The computer implemented system of claim 21, wherein said modules of said advertisement management platform further comprise a consumer analytics provisioning module that selectively provides said consumer analytics information to one or more retailers, advertisers, and marketing and branding service providers, whereby said retailers, said advertisers, and said marketing and branding service providers develop advertisement campaigns based on said consumer analytics information.

23. A computer program product comprising a non-transitory computer readable storage medium, said non-transitory computer readable storage medium storing computer program codes that comprise instructions executable by at least one processor, said computer program codes comprising:
a first computer program code for registering one or more consumers with an advertisement distribution service by creating a consumer profile for each of said one or more consumers, wherein said consumer profile comprises dynamic behavioral data of said each of said one or more consumers;
a second computer program code for targeting advertisements to said registered one or more consumers based on said dynamic behavioral data of said registered one or more consumers through one or more of a plurality of media and communication channels;
a third computer program code for engaging said registered one or more consumers with said targeted advertisements based on an advertisement engagement plan of said advertisement distribution service, wherein said advertisement engagement plan requires each of said registered one or more consumers to consume and provide a response to a predetermined number of said targeted advertisements within a predetermined time period;
a fourth computer program code for providing said registered one or more consumers with one or more incentives when said response from said each of said registered one or more consumers to one or more of said predetermined number of said targeted advertisements confirms consumption of said targeted advertisements; and
a fifth computer program code for enabling exchange of said one or more incentives stored in a mobile wallet application for retail transactions using an electronic commerce management server.
